(19) United States
(12) Patent Application Publication
(10) Pub. No.: US 2026/0198458 A1
(43) Pub. Date: Jul. 16, 2026

(54) SYSTEM, METHOD, AND APPARATUS FOR TRACKING AND MONITORING PET ACTIVITY

(71) Applicant: MARS, INCORPORATED, Mclean, VA (US)

(72) Inventors: Russ Ward Smith, San Francisco, CA (US); Shao Huang, San Francisco, CA (US); Borna Dehghani, San Francisco, CA (US)

(73) Assignee: MARS, INCORPORATED, Mclean, VA (US)

(21) Appl. No.: 19/133,175

(22) PCT Filed: Sep. 26, 2023
(86) PCT No.: PCT/US2023/033696

§ 371 Date: May 30, 2025

Related U.S. Application Data
(60) Provisional application No. 63/428,274, filed on Nov. 28, 2022.

(51) Int. Cl. A01K 27/00; A01K 29/00

(52) U.S. Cl. CPC A01K 27/001; A01K 29/007

(57) ABSTRACT

A wearable device attachment system for a pet is provided. The wearable device attachment system comprises a flexible case configured to receive a collar charm device therein, the case having a front and a back; a clip coupled to the back of the case, the clip comprising a one-piece unit having a top member, a bottom member, a first side member, a second side member, and a transverse member, wherein the top member is distanced from and opposite to the bottom member and the first side member is distanced from and opposite to the second side member, wherein the top and bottom members are curved away from the back of the case and the clip is symmetrical about the transverse member; wherein the clip is configured to couple with a collar band, the collar band is insertable and lockable between the back of the case and the clip.

### CROSS REFERENCE TO RELATED APPLICATIONS

This application claims priority to U.S. Patent Application No. 63/428,274 filed on Nov. 28, 2022, which is incorporated herein by reference in its entirety.

### TECHNICAL FIELD

This disclosure generally relates to pet tracking devices for collecting and analyzing data related to pet activity or other data.

### BACKGROUND

Mobile devices and/or wearable devices have been fitted with various hardware and software components that can help track human location. For example, mobile devices can communicate with a global positioning system (GPS) to help determine their location. More recently, mobile devices and/or wearable devices have moved beyond mere location tracking and can now include sensors that help to monitor human activity. The data resulting from the tracked location and/or monitored activity can be collected, analyzed and displayed. For example, a mobile device and/or wearable devices can be used to track the number of steps taken by a human for a preset period of time. The number of steps can then be displayed on a user graphic interface of the mobile device or wearable device.

The ever-growing emphasis on pet safety and health has resulted in an increased need to monitor pet behavior. Accordingly, there is an ongoing demand in the pet product industry for a system and/or method for tracking and monitoring pet activity. Yet, human wearable devices are often convenient to put on and take off, and thus it is easy to maintain regular downtime periods (e.g., when an individual is sleeping, showering, or idle) when the battery of the devices can be charged. Furthermore, human wearable devices can often stay attached to the user throughout various activities. As such, there remains a need for a wearable pet device attachment system that can accurately monitor pet activity and stay attached to the pet throughout various activities (e.g., walking on a leash or playing with other pets), while easily attach and detach to the pet to allow convenient downtime for maintenance and battery charging.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIGS. 1A-1D illustrate a front, side, back, and front view of a pet wearable device attachment system according to certain non-limiting embodiments.

FIGS. 2A and 2B illustrate a side and back view of a pet wearable device attachment system being attached to a collar band according to certain non-limiting embodiments.

FIGS. 3A and 3B illustrate a front and back view of a collar charm device according to certain non-limiting embodiments.

FIG. 4 illustrates a system diagram used to track and monitor a pet according to certain non-limiting embodiments.

FIG. 5 illustrates a device that can be used to track and monitor a pet according to certain non-limiting embodiments.

FIG. 6 illustrates a logical block diagram of a device that can be used to track and monitor a pet according to certain non-limiting embodiments.

FIGS. 7A and 7B illustrate expanded views of packages without and with pet wearable device attachment system, and FIG. 7C illustrates a closed package view according to certain non-limiting embodiments.

### DESCRIPTION OF EXAMPLE EMBODIMENTS

There remains a need for a system, method, and device that can monitor and track pet activity and stay attached to the pet throughout various activities, while easily attach and detach to the pet to allow convenient downtime for maintenance and battery charging. The wearable device attachment system comprises a flexible case configured to receive a collar charm device therein, the case having a front and a back; a clip coupled to the back of the case, the clip comprising a one-piece unit having a top member, a bottom member, a first side member, a second side member, and a transverse member, wherein the top member is distanced from and opposite to the bottom member and the first side member is distanced from and opposite to the second side member, wherein the top and bottom members are curved away from the back of the case and the clip is symmetrical about the transverse member; wherein the clip is configured to couple with a collar band, the collar band is insertable and lockable between the back of the case and the clip.

In certain embodiments, the case surrounds the transverse member to form a bump on the back of the case, wherein the bump is configured to couple the clip with the case, wherein the collar band is lockable between a back surface of the bump and front surfaces of the first and second side members. In some embodiments, the back surface of the bump interfaces with collar band to prevent the collar band from dislodging from the clip.

In certain embodiments, the collar band is curved towards the back of the case when locked with the clip. In certain embodiments, a curvature of the collar band prevents the collar band from dislodging from the clip.

In certain embodiments, the clip is configured to be removably attached to the collar band. In certain embodiments, the transverse member is coupled with the top member of the clip, wherein the collar band inserts through a front surface of the bottom member of the clip. In certain embodiments, a width of the collar band is less than the distance between the top member and the bottom member.

In certain embodiments, the wearable device attachment system further comprises a collar charm device that couples with the case. In some embodiments, the collar charm device has a front face, a bottom face, and a sidewall disposed between the front face and the bottom face, wherein the sidewall comprises a frictioned surface. In some embodiments, the flexible case comprises an elastomer material, wherein the frictioned surface of the sidewall interfaces with the interior sidewall of the flexible case to secure the collar charm within the case.

U.S. patent application Ser. Nos. 17/525,335 and 17/621,670, U.S. Provisional Application Nos. 62/866,225, 62/970,575, 63/007,896, and 63/113,670, and U.S. Design Application Nos. 29/861,165, 29/868,249, 29/868,251 are hereby incorporated by reference. The entire subject matter disclosed in the above referenced applications, including the specification, claims, and figures are incorporated herein.

### DETAILED DESCRIPTION

The present disclosure relates to wearable device attachment system for a pet. For clarity and not by way of limitation, the detailed description of the presently disclosed subject matter is divided into the following subsections for clarity and not limitation: 1. Definitions; 2. Pet wearable device attachment system; 3. Pet wearable device and system; and 4. Package for protecting wearable device and device accessory.

### 1. Definitions

The terms used in this specification generally have their ordinary meanings in the art, within the context of this disclosure and in the specific context where each term is used. Certain terms are discussed below, or elsewhere in the specification, to provide additional guidance in describing the compositions and methods of the disclosure and how to make and use them.

As used in the specification and the appended claims, the singular forms “a,” “an” and “the” include plural referents unless the context clearly dictates otherwise.

As used herein, the terms “comprises,” “comprising,” or any other variation thereof, are intended to cover a non-exclusive inclusion, such that a process, method, article, system, or apparatus that comprises a list of elements does not include only those elements but can include other elements not expressly listed or inherent to such process, method, article, or apparatus.

In the detailed description herein, references to “embodiment,” “an embodiment,” “one embodiment,” “in various embodiments,” “certain embodiments,” “some embodiments,” “other embodiments,” “certain other embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

In general, terminology can be understood at least in part from usage in context. For example, terms, such as “and”, “or”, or “and/or,” as used herein can include a variety of meanings that can depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, can be used to describe any feature, structure, or characteristic in a singular sense or can be used to describe combinations of features, structures or characteristics in a plural sense. Similarly, terms, such as “a,” “an,” or “the,” again, can be understood to convey a singular usage or to convey a plural usage, depending at least in part upon context. In addition, the term “based on” can be understood as not necessarily intended to convey an exclusive set of factors and can, instead, allow for existence of additional factors not necessarily expressly described, again, depending at least in part on context.

The term “animal” or “pet” as used in accordance with the present disclosure can refer to domestic animals including, domestic dogs, domestic cats, horses, cows, ferrets, rabbits, pigs, rats, mice, gerbils, hamsters, goats, and the like. Domestic dogs and cats are particular non-limiting examples of pets. The term “animal” or “pet” as used in accordance with the present disclosure can also refer to wild animals, including, but not limited to bison, elk, deer, venison, duck, fowl, fish, and the like.

The term “pet product” can include, for example and without limitation, any type of product, service, or equipment that is designed, manufactured, and/or intended for use by a pet. For example, the pet product can be a toy, a chewable, a food, an item of clothing, a collar, a medication, a health tracking device, a location tracking device, and/or any combination thereof.

The term “pet owner” or “pet guardian” can include any person, organization, and/or collection of persons that owns and/or is responsible for any aspect of the care of a pet.

In certain non-limiting embodiments, a wearable device can include one or more sensors. The term “sensor” can refer to any hardware or software used to detect a variation of a physical quantity caused by activity or movement of the pet, such as an actuator, a gyroscope, a magnetometer, microphone, pressure sensor, or any other device that can be used to detect an object's displacement. In one non-limiting example, the sensor can be a three-axis accelerometer. The one or more sensors or actuators can be included in a microelectromechanical system (MEMS). A MEMS, also referred to as a MEMS device, can include one or more miniaturized mechanical and/or electro-mechanical elements that function as sensors and/or actuators and can help to detect positional variations, movement, and/or acceleration. In other embodiments any other sensor or actuator can be used to detect any physical characteristic, variation, or quantity. The wearable device can also include one or more transducers. The transducer can be used to transform the physical characteristic, variation, or quantity detected by the sensor and/or actuator into an electrical signal, which can be transmitted from the one or more wearable device through a network to a server.

The term “client device” can, for example and without limitation, refer to a computing system or mobile device used by a user of a given mobile application. In particular, the computing system can comprise functionality for determining its location, direction, or orientation, such as a GPS receiver, compass, gyroscope, or accelerometer. Client device can also include functionality for wireless communication, such as BLUETOOTH communication, near-field communication (NFC), or infrared (IR) communication or communication with wireless local area networks (WLANs) or cellular-telephone network. Such a device can also include one or more cameras, scanners, touchscreens, microphones, or speakers. Client devices can also execute software applications, such as games, web browsers, or social-networking applications. Client devices, for example, can include user equipment, smartphones, tablet computers, laptop computers, desktop computers, or smartwatches.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module can be stored on a computer readable medium for execution by a processor. Modules can be integral to one or more servers, or be loaded and executed by one or more servers. One or more modules can be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

### 2. Pet Wearable Device Attachment System

The disclosed subject matter provides a wearable device attachment system for a pet that ensures secure attachment to the pet while allowing easy attaching and detaching to the pet for convenient maintenance and battery charging.

In certain non-limiting embodiments, the disclosed subject matter provides a pet wearable device attachment system. The wearable device attachment system enables a wearable device to be placed on a collar of the pet, and the wearable device can be used to track, monitor, and/or detect the activity of the pet using one or more sensors. In other non-limiting embodiments, the wearable device attachment system can comprise a computing device designed to be worn, or otherwise carried, by a pet or animal in any other location other than the collar. For example, the wearable device can be wore or attached to a harness or a clothing of a pet. Although this disclosure describes and illustrates a system having a certain number of components in an arrangement, this disclosure contemplates any suitable system having any suitable number of components in any arrangement.

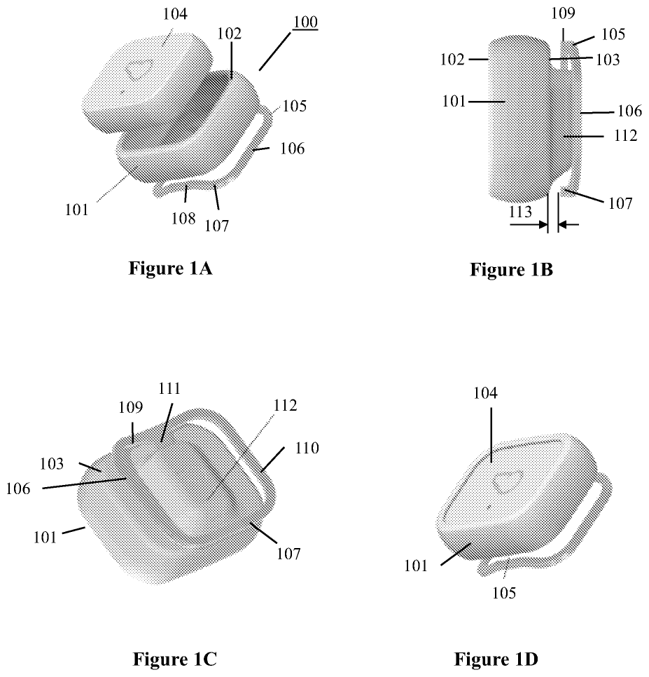

As example and not by way of limitation, as shown in FIG. 1A, the pet wearable device attachment system or wearable device 100 comprises a case 101 and a clip 105. In certain non-limiting embodiments, the case 101 is a flexible case. In one example, the flexible case 101 comprises an elastomer material, e.g., silicon. In one non-limiting embodiment, the case 101 has a front 102 and a back 103 and the clip 105 is coupled to the back of the case (103) (FIGS. 1A-1C). In another non-limiting embodiment, the clip 105 is secured with the flexible case. In certain non-limiting embodiments, the case 101 is configured to receive a collar charm device 104. In one example, the front of the case is configured to receive the collar charm device 104.

In certain embodiments, as shown in FIG. 1C, the clip 105 comprises a one-piece unit having a top member 109, a bottom member 107, a first side member 106, a second side member 110, and a transverse member 111. In certain embodiments, the transverse member 111 is coupled with the top member 109 of the clip. In one non-limiting embodiment, the top member 109 is distanced from and opposite to the bottom member 107, and the first side member 106 is distanced from and opposite to the second side member 110. In one non-limiting embodiment, the top member 109 and the bottom member 107 are curved away from the back of the case and the clip 105 is symmetrical about the transverse member 111. In one embodiment, the top member 109 and the bottom member 107 each comprises a flat surface in the middle. As an example and not by way of limitation, as shown in FIG. 1A, the bottom member 107 comprises a flat surface 108 and the sides of the bottom member 107 curve away from the flat surface 108. In certain embodiments, the case 101 surrounds the transverse member 111 to form a bump 112 on the back of the case 105, wherein the bump 112 is configured to couple the clip 105 with the case 101. The clip 105 can be made from, for example, plastic, metals, or any suitable material.

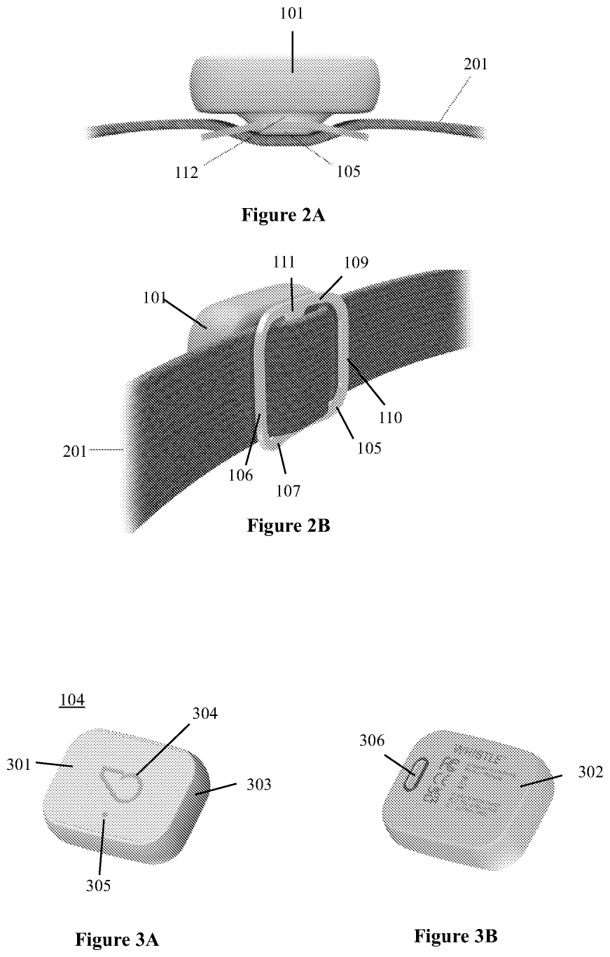

In certain non-limiting embodiments, the clip 105 is configured to couple with a collar band 201 (FIGS. 2A and 2B). The collar band 201 can also be referred to as simply as a collar, a pet collar, a band, or a strap. The collar band can be sized to fit all sized pets, whether it be small, medium, or large pets. The collar band can be made of leather, nylon, cotton, rubber, polyester, hemp, or another suitable material. In certain non-limiting embodiments, the collar band comprises an adjustment mechanism, e.g., a buckle, a side-release buckle, a strap, a snap hook, D-rings, or O-rings (not shown herein). In certain embodiments, the collar band 201 can be inserted through a gap 113 between the bottom member 107 and the back of the case 101 (FIG. 1B). In other words, the collar band 201 can be inserted through a front surface of the bottom member 107 of the clip 105. In a more specific example, the collar band 201 can be inserted through the gap between the back of the case 101 and the front surface of the bottom member 107. In one non-limiting embodiment, the collar band 201 can also be removed from the clip 105 through the gap 113. In one non-limiting embodiment, a width of the collar band 201 is less than the distance between the top member 109 and the bottom member 107 of the clip 105. In other words, the distance between the top member 109 and the bottom member 107 is greater than a width of the collar band 201. In other non-limiting embodiment, the width of the collar band 201 is approximately the same as the distance between the top member 109 and the bottom member 107 of the clip 105. In other non-limiting embodiments, the width of the collar band 201 is greater than the distance between the top member 109 and the bottom member 107 of the clip 105.

In certain non-limiting embodiments, as shown in FIGS. 2A and 2B, after insert, the collar band 201 is lockable between the back of the case 101 and the clip 105. In one non-limiting embodiment, the collar band 201 is lockable between a back surface of the bump 112 and front surfaces of the first and second side members (106 and 110) of the clip 105 (FIG. 2A). In this example, the back surface of the bump 112 interfaces with the collar band 201 to prevent the collar band 201 from dislodging from the clip 105. In a more specific example, the flexible case 101, including the bump 112, comprises an elastomer material, e.g., silicon. As such, the friction between the bump 112 made of elastomer material and the collar band 201 prevents the collar band 201 from dislodging from the clip 105. Additionally, after insert, the collar band is curved towards the back of the case 101 when locked with the clip 105 due to the configuration of the bump 112 and the curvature of the clip 105 (FIG. 2A). In this example, the curvature of the collar band 201 prevents the collar band from dislodging from the clip. In another non-limiting embodiment, both the friction between the bump 112 and the collar band 201, and the curvature of the collar band 201 lock the clip 105 to the collar band 201, preventing the collar band 201 from dislodging from the clip 105.

In certain non-limiting embodiments, as shown in FIG. 1A, the wearable device attachment system 100 further comprises a collar charm device 104 that couples with the case 101. The collar charm device 104 can be device as shown in FIGS. 3A and 3B. In one non-limiting embodiment, the collar charm device 104 has a front face 301, a bottom face 302, and a sidewall 303 disposed between the front face 301 and the bottom face 302. The front face 301 can comprise a first material and the back face 302 can comprise a second material such that the first material is different from the second material. In other embodiments, the first and second material can be the same. These materials can include, for example, plastic, metals, or any suitable material. In certain non-limiting embodiments, the front face 301 and the back face 302 can include a coating or finish, for example a polished Physical Vapor Deposition (PVD)-coated gloss or high-gloss finish, or a PVD-coated matte finish. In one non-limiting embodiment, the sidewall 303 comprises same materials as the first material of the front face 301 or the second material of the back face 302. In other embodiments, the sidewall 303 comprises a frictioned surface. In one example, the case 101 comprises an elastomer material, and the frictioned surface of the sidewall 303 interfaces with the interior sidewall of the case 101 to secure the collar charm device 104 within the case 101. In another example, the frictioned surface of the sidewall 114 also comprises an elastomer material, plastic, or metals. In one non-limiting embodiment, the case 101 and the sidewall 114 are made from the same material. In another non-limiting embodiment, the case 101 and the sidewall 114 are made from different materials. As an example, the case 101 and the sidewall 114 are made from silicon with different crosslinking densities. In another non-limiting embodiment, the front of the case 101 comprises a rim and the rim also secures the collar charm device 104 within the case 101 (FIGS. 1A and 1D).

In certain non-limiting embodiments, the housing of the collar charm device 104, for example, the front face 301 and the back face 302 comprises indicia. The indicia can be any suitable symbols, text, insignias, and the like. The indicia can be printed and/or engraved on the housing of the wearable device by any suitable method and can be made of any suitable material. Further, the housing can include personalized features, such as an engraving that features the wearer's name or other identifying information, such as a pet owner name and phone number. One or more indicia can include one or more aesthetic features, for example a debossed finish, a metal sticker on a debossed surface, or other aesthetic features. As example and not by way of limitation, as shown in FIG. 3A, a metallic logo 304 is printed on the front face of the wearable device.

In certain non-limiting embodiments, the wearable device can also include one or more USB ports that can be used to connect to a cable, such as USB cable or the like, to transmit data and/or to charge the battery of the collar charm device or the wearable device attachment system. As an example, the collar charm device 104 includes a USB port 306 on the back face 302. The one or more USB ports can be for example, a type-A universal serial bus (“USB”) port, a type-B USB port, a mini-USB port, a micro-USB port, or any other type of port. In some other non-limiting embodiments, the battery of collar charm device 104 can be wirelessly charged.

In certain embodiments, the collar charm device 104 can further include the inner mechanisms for the functional operation of the tracking component, such as antenna, main Printed Circuit Board Assembly, USB port, and inner hardware, such as one or more screws, to couple together one or more components of the collar charm device 104, amongst other mechanisms. The antenna can be constructed of a specialized polycarbonate component that is compatible with the Laser Direct Structuring (LDS) process that “deposits” or plates the antenna pattern on the physical carrier. The antenna can be a Bluetooth antenna, near field communication antenna, cellular communication antenna, WLAN antenna, or any other antenna that helps to facilitate communications and/or location tracking. In one non-limiting embodiment, the antenna has a circle or round shape to accommodate or reduce interference from the metallic logo 304 and/or metallic clip 105.

In one non-limiting embodiment, the front face 301 of the collar charm device 104 comprises one or more indicators, for example, indicator 305. As an example, the indicator 305 can be, for example, an LED or other light indicator, and provide a visual indication of the wireless connectivity of wearable device, the state of charge of battery component, whether battery component is connected to wearable device, or the battery level. In one non-limiting embodiment, the indicator 305 is a status indicator that can communicate a status of the device, such as a charging mode (reflective of a first color), an engagement mode (such as when interacting with a Bluetooth communication and reflective of a second color), and a fully charged mode (such as when a battery life is above a predetermined threshold and reflective of a third color). For example, when the indicator 305 is amber colored the wearable can be charging. On the other hand, when indicator 305 is green the battery of the wearable device can be said to be fully charged. Other status modes and colors thereof of the indicator 305 are contemplated herein. The indicator 305 can furthermore blink or have a select pattern of blinking that can be indicative of a certain status. The front face 302 can include any suitable color and pattern, and can further include a reflective material or a material that glows in the dark.

The collar charm device 104 can further include a status indicator such as an illumination device (such as but not limited to a light or light emitting diode), a sound device, and a vibrating device. The status indicator can be housed within the collar charm device, positioned on the front face 301 or on the back face 302 of the device. In other embodiments, a sound device and/or a vibrating device can be provided with the collar charm device 104. The sound device can include a speaker and make sounds such as a whistle or speech upon a trigger event. In certain non-limiting embodiments, the status indicator, for example, indicator 305, can have different colors indicating the charge level of the battery and/or the type of radio access technology to which collar charm device 104 is connected. In certain non-limiting embodiments, status indicator can be activated manually or automatically once the pet exits the geo-fence zone. Alternatively, or in addition to, a user can manually activate status indicator using an application on the mobile device based on data received from the wearable device. Although status indicator is shown as a light, the status indicator can be replaced with an illumination device, a sound device, and/or a vibrating device.

The indicator 305 can communicate a status of the device, such as a charging mode (reflective of a first color), an engagement mode (such as when interacting with a Bluetooth communication and reflective of a second color), and a fully charged mode (such as when a battery life is above a predetermined threshold and reflective of a third color). For example, the indicator 305 can be blue, meaning that collar charm device 104 is either connected via Bluetooth and/or currently communicating with another device via a Bluetooth network. In certain non-limiting embodiments, the wearable device using the Bluetooth Low Energy (BLE) can be advantageous. BLE can be a wireless personal network that can help to reduce power and resource consumption by the wearable device. Using BLE can therefore help to extend the battery life of the wearable device. Other status modes and colors thereof of status indicator 305 are contemplated herein. The status identifier can furthermore blink or have a select pattern of blinking that can be indicative of a certain status. The front face 301 can include any suitable color and pattern, and can further include a reflective material or a material that glows in the dark.

The collar charm device 104 can sense, detect, or collect data related to the pet from one or more sensors. The data can include, for example, data related to location or movement of the pet. In certain non-limiting examples, the wearable device can include one or more sensors, which can allow the wearable device to detected movement of the pet. In some non-limiting embodiments, the sensor can be a triaxial accelerometer, which can allow the collar charm device 104 to detect various body movements of the pet. The various body movement can include, for example, any bodily movement associated with scratching, licking, walking, running, drinking, eating, sleeping, sleep disruptions, and shaking, and/or any other bodily movement associated with an action performed by the pet. In certain examples, the one or more sensors can detect a pet jumping around, excited for food, eating voraciously, drinking out of the bowl, pet movement during typical sleep times, playing with other pets, and/or walking around the room. The one or more sensors can also detect activity of a pet after a medical procedure or veterinary visit, such as a castration or ovariohysterectomy visit. In some non-limiting embodiments, the user can manually upload an event to assist in the tracking and monitoring of the pet. For example, the user can create a sleeping event that details the duration of seep for the pet, or the times and quantity of food that the pet consumed on a particular date. The logged events can help with the tracking or monitoring of the pet. In certain non-limiting embodiments, the one or more sensors can be used in combination with a GPS receiver, for example. In one non-limiting embodiment, the GPS receiver can instead be a Global Navigation Satellite System (GLONASS) receiver.

In certain non-limiting embodiments, the collar charm device 104 can further comprise one or more of an altimeter and a barometer for determining the location and/or the elevation of the wearable device. In certain non-limiting embodiments, the altimeter and the barometer can collect data comprises a device elevation and/or a corresponding timestamp. A computing system can utilize the timestamp to determine a location that corresponds to the device elevation data based on the GPS data or network data. This additional data permits the computing system to determine a more accurate location of the wearable device. For example, if a user lives in a multi-story residential building, elevation data permits the computing system to determine whether the user's pet is located in the user's condo on the 14^{th} floor, at the outdoor space on the roof of the building, or in the lobby.

In certain non-limiting embodiments, the data collected via the one or more sensors can be combined with data collected from other sources. In one non-limiting example, the data collected from the one or more sensors can be combined with video and/or audio data acquired using a video recording device. Combining the data from the one or more sensors and the video recording device can be referred to as data preparation. During data preparation, the video and/or audio data can utilize video labeling, such as behavioral labeling software. The video and/or audio data can be synchronized and/or stored along with the data collected from the one or more sensors. The synchronization can include comparing sensor data to video labels, and aligning the sensor data with the video labels to minute, second, or sub-second accuracy. The data can be aligned manually by a user or automatically, such as using a semi-supervised approach to estimate offset. The combined data from the one or more sensors and video recording device can be analyzed using machine learning or any of the algorithms describes herein. The data can also be labeled as training data, validation data, and/or test data.

### 3. Pet Wearable Device System

The presently disclosed subject matter also relates to a computer system that track, monitor, and analyze the activity of the pet.

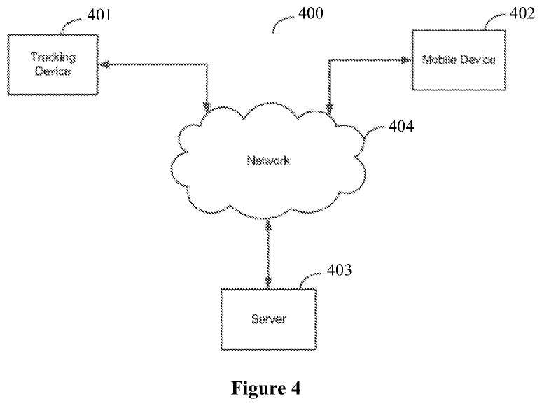

FIG. 4 illustrates a system diagram used to track and monitor a pet according to certain non-limiting embodiments. In particular, as illustrated in FIG. 4, the system 400 can include a tracking device 401, a mobile device 402, a server 403, and/or a network 404. Tracking device 401 can be a wearable device as shown in FIGS. 1-3. The wearable device can be placed through a wearable device attachment system as shown in FIGS. 1-2 onto a collar of the pet, and can be used to track, monitor, and/or detect the activity of the pet using one or more sensors. In other non-limiting embodiments, tracking device 401 can comprise a computing device designed to be worn, or otherwise carried, by a pet or animal in any other location other than the collar. Although this disclosure describes and illustrates a system having a certain number of components in an arrangement, this disclosure contemplates any suitable system having any suitable number of components in any arrangement.

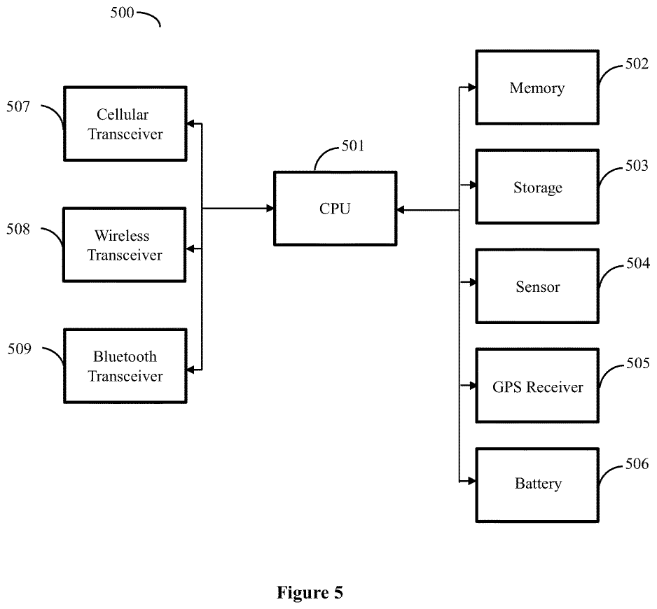

In one non-limiting embodiment, tracking device 401 can include the hardware illustrated in FIG. 5. The tracking device 401 can be configured to collect data generated by various hardware or software components, generally referred to as sensors, present within the tracking device 401. For example, a GPS receiver or one or more sensors, such as accelerometer, gyroscope, or any other device or component used to record, collect, or receive data regarding the movement or activity of the tracking device 401. The activity of tracking device 401, in some non-limiting embodiments, can mimic the movement of the pet on which the tracking device is located. While tracking device 401 can be attached to the collar of the pet, as described in U.S. patent application Ser. No. 14/231,615, hereby incorporated by reference in its entirety, in other embodiments tracking device 401 can be attached to any other item worn by the pet. In some non-limiting embodiments, tracking device 401 can be located on or inside the pet itself, such as, for example, a microchip implanted within the pet.

As discussed in more detail herein, tracking device 401 can further include a processor capable of processing the one or more data collected from tracking device 401. The processor can be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors can be implemented as a single controller, or a plurality of controllers or processors. In certain non-limiting embodiments, processor 501 includes hardware for executing instructions, such as those making up a computer program. As an example and not by way of limitation, to execute instructions, processor 501 can retrieve (or fetch) the instructions from an internal register, an internal cache, memory 502, or storage 503; decode and execute them; and then write one or more results to an internal register, an internal cache, memory 502, or storage 503. In certain non-limiting embodiments, processor 501 can include one or more internal caches for data, instructions, or addresses. This disclosure contemplates processor 501 including any suitable number of any suitable internal caches, where appropriate. As an example and not by way of limitation, processor 501 can include one or more instruction caches, one or more data caches, and one or more translation lookaside buffers (TLBs). Instructions in the instruction caches can be copies of instructions in memory 502 or storage 503, and the instruction caches can speed up retrieval of those instructions by processor 501. Data in the data caches can be copies of data in memory 502 or storage 503 for instructions executing at processor 501 to operate on; the results of previous instructions executed at processor 501 for access by subsequent instructions executing at processor 501 or for writing to memory 502 or storage 503; or other suitable data. The data caches can speed up read or write operations by processor 501. The TLBs can speed up virtual-address translation for processor 501. In certain non-limiting embodiments, processor 501 can include one or more internal registers for data, instructions, or addresses. This disclosure contemplates processor 501 including any suitable number of any suitable internal registers, where appropriate. Where appropriate, processor 501 can include one or more arithmetic logic units (ALUs); be a multi-core processor; or include one or more processors 501. Although this disclosure describes and illustrates a particular processor, this disclosure contemplates any suitable processor.

In some non-limiting embodiments, the tracking device 401 can specifically be configured to collect, sense, or receive data, and/or pre-process data prior to transmittal. In addition to sensing, recording, and/or processing data, tracking device 401 can further be configured to transmit data, including location and any other data monitored or tracked, to other devices or severs via network 404. In certain non-limiting embodiments, tracking device 401 can transmit any data tracked or monitored data continuously to the network 404. In other non-limiting embodiments, tracking device 401 can discretely transmit any tracked or monitored data. Discrete transmittal can be transmitting data after a finite period of time. For example, tracking device 401 can transmit data once an hour. This can help to reduce the battery power consumed by tracking device 401, while also conserving network resources, such as bandwidth.

As shown in FIG. 4, tracking device 401 can communicate with network 404. Although illustrated as a single network, network 404 can comprise multiple or a plurality of networks facilitating communication between devices. This disclosure contemplates any suitable network and any suitable communication interface for it. Network 404 can be a radio-based communication network that uses any available radio access technology. Available radio access technologies can include, for example, Bluetooth, wireless local area network (“WLAN”), Global System for Mobile Communications (GMS), Universal Mobile Telecommunications System (UMTS), any Third Generation Partnership Project (“3GPP”) Technology, including Long Term Evolution (“LTE”), LTE-Advanced, Third Generation technology (“3G”), or Fifth Generation (“5G”)/New Radio (“NR”) technology. Network 404 can use any of the above radio access technologies, or any other available radio access technology, to communicate with tracking device 401, server 403, and/or mobile device 402. Tracking device 401 can include any suitable communication interface for any of these networks, where appropriate. Communication interface can include one or more communication interfaces, where appropriate. Although this disclosure describes and illustrates a particular communication interface, this disclosure contemplates any suitable communication interface.

In one non-limiting embodiment, the network 404 can include a WLAN, such as a wireless fidelity (“Wi-Fi”) network defined by the IEEE 802.11 standards or equivalent standards. In this embodiment, network 404 can allow the transfer of location and/or any tracked or monitored data from tracking device 401 to server 403. Additionally, the network 404 can facilitate the transfer of data between tracking device 401 and mobile device 402. In an alternative embodiment, the network 404 can comprise a mobile network such as a cellular network. In this embodiment, data can be transferred between the illustrated devices in a manner similar to the embodiment wherein the network 404 is a WLAN. In certain non-limiting embodiments tracking device 401, also referred to as wearable device, can reduce network bandwidth and extend battery life by transmitting when data to server 403 only or mostly when it is connected to the WLAN network.

In certain non-limiting embodiments, the tracking device 401 can enter a power-save mode upon certain criteria being triggered. The power-saving mode can help to extend the battery life of tracking device 401. The criteria for entering power-saving mode can comprise, for example, when the tracking device is not connected to a WLAN, when a predetermined period of inactivity occurs, or after a given period of time in which the pet remains idle. After entering power-saving mode, the operating system can continue to monitor or track data, but not transmit any of the collected data to server 403. In some other non-limiting examples, in power-saving mode wearable device 402 can restrict or delay the completion of various work items (e.g., sending information to server 403, or outputting alerts or notifications). In some non-limiting embodiments, a scheduler associated with the operating system can determine how the work items should be processed (e.g., whether the work item prohibits the CPU from entering power-save mode). The power saving mode can be activated manually by a user or automatically by the mobile device.

In certain non-limiting embodiments, a user can select, using a graphical user interface (GUI) of the mobile device, an interval or time period in which the tracking device should check-in over a wireless connection. When checking-in, the tracking device can inquire whether the internal or time period can be a valid time for the tracking device to upload accelerometer data to the mobile device. For example, the interval or time period for the wireless check-in can be 3 minutes, 6 minutes, 10 minutes, 30 minutes, or any other time period. Once the interval or time period is selected by the user, the tracking device can be updated to check-in on the selected interval or time period. The longer the selected interval or time period, the less battery power can be consumed. For example, a check-in interval of 3 minutes will consume more battery power than a 30-minute interval.

During power-saving mode, also referred to as a sleep mode, one or more cores of the CPU in the wearable device can remain in the power-saving mode until a wake-up signal is received. This results in efficient power usage and extended battery life. In some non-limiting embodiments, one or more cores of the CPU can persistently monitor the network for a condition or work item request that would trigger the wearable device to exit power-saving mode. In some non-limiting embodiments, the wearable device can be passively listening to one or more given frequencies (e.g., cellular frequency), even during power-saving mode. In such embodiments, the wearable device can exit the power-saving mode after receiving a push communication from a server or mobile device to the wearable device. The push communication can be transmitted through a cellular network, and/or can be activated via an application on a mobile device. The push communication can be used to remotely update one or more settings on the tracking device, such as activation of the GPS receiver, or activation of an auditory or visual alert.

In one non-limiting embodiment, tracking device 401 and mobile device 402 can transfer data directly between the devices. Such direct transfer can be referred to as device-to-device communication or mobile-to-mobile communication. While described in isolation, network 404 can include multiple networks. For example, network 404 can include a Bluetooth network that can help to facilitate transfers of data between tracking device 401 and mobile device 402, a wireless land area network, and a mobile network.

The system 400 can further include a mobile device 402. Mobile device 402 can be any available user equipment or mobile station, such as a mobile phone, a smart phone or multimedia device, or a tablet device. In alternative embodiments, mobile device 402 can be a computer, such as a laptop computer, provided with wireless communication capabilities, personal data or digital assistant (PDA) provided with wireless communication capabilities, portable media player, digital camera, pocket video camera, navigation unit provided with wireless communication capabilities or any combinations thereof. As discussed previously, mobile device 402 can communicate with a tracking device 401. In these embodiments, mobile device 402 can receive location, data related to a pet, wellness assessment, and/or health recommendation from a tracking device 401, server 403, and/or network 404. Additionally, tracking device 401 can receive data from mobile device 402, server 403, and/or network 404. In one non-limiting embodiment, tracking device 401 can receive data regarding the proximity of mobile device 402 to tracking device 401 or an identification of a user associated with mobile device 402. A user associated with mobile device 402, for example, can be an owner of the pet.

Mobile device 402 (or non-mobile device) can additionally communicate with server 403 to receive data from server 403. For example, server 403 can include one or more application servers providing a networked application or application programming interface (API). In one non-limiting embodiment, mobile device 402 can be equipped with one or more mobile or web-based applications that communicates with server 403 via an API to retrieve and present data within the application. In one non-limiting embodiment, server 403 can provide visualizations or displays of location or data received from tracking device 401. For example, visualization data can include graphs, charts, or other representations of data received from tracking device 401.

In certain non-limiting embodiments, the wearable device system can be used to assess pet wellness. In one non-limiting embodiment, data related to the pet can be received. The data can be received from at least one of the following data sources: a wearable pet tracking or monitoring device, genetic testing procedure, pet health records, pet insurance records, and/or input from the pet owner. One or more of the above data sources can collected using separate sources. After the data is received it can be aggregated into one or more databases. The process or method can be performed by any device, hardware, software, algorithm, or cloud-based server described herein.

Based on the received data, one or more health indicators of the pet can be determined. For example, the health indicators can include a metric for licking, scratching, itching, walking, sleeping, and/or sleep disruptions by the pet. For example, a metric can be the number of minutes per day a pet spends sleeping, and/or the number or minutes per day a pet spends walking, running, or otherwise being active. Any other metric that can indicate the health of a pet can be determined. In some non-limiting embodiments, a wellness assessment of the pet can be performed based on the one or more health indicators. The wellness assessment, for example, can include evaluation and/or detection of dermatological condition(s), dermatological disease(s), ear/eye infection, arthritis, cardiac episode(s), cardiac condition(s), cardiac disease(s), allergies, dental condition(s), dental disease(s), kidney condition(s), kidney disease(s), cancer, endocrine condition(s), endocrine disease(s), deafness, depression, insomnia, sleep apnea, rapid eye movement (REM) behavioral disorders pancreatic episode(s), pancreatic condition(s), pancreatic disease(s), obesity, metabolic condition(s), metabolic disease(s), and/or any combination thereof. The wellness assessment can also include any other health condition, diagnosis, or physical or mental disease or disorder currently known in veterinary medicine.

Based on the wellness assessment, a recommendation can be determined and transmitted to one or more of a pet owner, a veterinarian, a researcher and/or any combination thereof. The recommendation, for example, can include one or more health recommendations for preventing the pet from developing one or more of a disease, a condition, an illness and/or any combination thereof. The recommendation, for example, can include one or more of: a food product, a pet service, a supplement, an ointment, a drug to improve the wellness or health of the pet, a pet product, and/or any combination thereof. In other words, the recommendation can be a nutritional recommendation. In some embodiments, a nutritional recommendation can include an instruction to feed a pet one or more of: a chewable, a supplement, a food and/or any combination thereof. In some embodiments, the recommendation can be a medical recommendation. For example, a medical recommendation can include an instruction to apply an ointment to a pet, to administer one or more drugs to a pet and/or to provide one or more drugs for or to a pet.

In other non-limiting embodiments, a surcharge and/or discount can be determined and/or applied to a base cost or premium for a health insurance policy of the pet. This determination can be either automatic or manual. Any updates to the surcharge and/or discount can be determined periodically, discretely, and/or continuously. For example, the surcharge or discount can be determined periodically every several months or weeks. In some non-limiting embodiments, the surcharge or discount can be determined based on the data received after a recommendation has been transmitted to one or more pet owner. In other words, the data can be used to monitor and/or track whether one or more pet owners are following and/or otherwise complying with one or more provided recommendations. If a pet owner follows and/or complies with one or more of the provided recommendations, a discount can be assessed or applied to the base cost or premium of the insurance policy. On the other hand, if one or more pet owners fails to follow and/or comply with the provided recommendation(s), a surcharge and/or increase can be assessed or applied to the base cost or premium of the insurance policy. In certain non-limiting embodiments the surcharge or discount to the base cost or premium can be determined based on one or more of the data, wellness assessment, and/or recommendation.

FIG. 5 illustrates a device that can be used to track and monitor a pet according to certain non-limiting embodiments. The device 500 can be, for example, tracking device 401, server 403, or mobile device 402. Device 500 includes a processor (CPU) 501, memory 502, non-volatile storage 503, sensor 504, GPS receiver 505, battery 506, cellular transceiver 507, wireless transceiver 508, such as a WiFi or WLAN transceiver, and/or Bluetooth transceiver 509. The device can include any other hardware, software, processor, memory, transceiver, and/or graphical user interface.

As discussed with respect to FIG. 5, the device 500 can a wearable device designed to be worn by, or otherwise connected to, a pet. The device 500 includes one or more sensors 504, such as a three-axis accelerometer. The one or more sensors can be used in combination with GPS receiver 505, for example. GPS receiver 505 can be used along with sensor 504 which monitor the device 500 to identify its position (via GPS receiver 505) and its acceleration, for example, (via sensor 504). Although illustrated as single components, sensor 504 and GPS receiver 505 can alternatively each include multiple components providing similar functionality. In certain non-limiting embodiment, GPS receiver 505 can instead be a Global Navigation Satellite System (GLONASS) receiver.

Sensor 504 and GPS receiver 505 generate data as described in more detail herein and transmits the data to other components via CPU 501. Alternatively, or in conjunction with the foregoing, sensor 504 and GPS receiver 505 can transmit data to memory 502 for short-term storage. In one non-limiting embodiment, memory 502 can comprise a random-access memory device or similar volatile storage device. In certain non-limiting embodiments, memory 502 includes main memory for storing instructions for processor 501 to execute or data for processor 501 to operate on. As an example and not by way of limitation, computer system 400 can load instructions from storage 503 or another source to memory 502. Processor 501 can then load the instructions from memory 502 to an internal register or internal cache. To execute the instructions, processor 501 can retrieve the instructions from the internal register or internal cache and decode them. During or after execution of the instructions, processor 501 can write one or more results (which can be intermediate or final results) to the internal register or internal cache. Processor 501 can then write one or more of those results to memory 502. In certain non-limiting embodiments, processor 501 executes only instructions in one or more internal registers or internal caches or in memory 502 (as opposed to storage 503 or elsewhere) and operates only on data in one or more internal registers or internal caches or in memory 502 (as opposed to storage 503 or elsewhere). One or more memory buses (which can each include an address bus and a data bus) can couple processor 501 to memory 502. In certain non-limiting embodiments, one or more memory management units (MMUs) reside between processor 501 and memory 502 and facilitate accesses to memory 502 requested by processor 501. In certain non-limiting embodiments, memory 502 includes random access memory (RAM). This RAM can be volatile memory, where appropriate. Where appropriate, this RAM can be dynamic RAM (DRAM) or static RAM (SRAM). Moreover, where appropriate, this RAM can be single-ported or multi-ported RAM. This disclosure contemplates any suitable RAM. Memory 502 can include one or more non-transitory (and/or non-volatile) memories 502, where appropriate. Although this disclosure describes and illustrates a particular memory component, this disclosure contemplates any suitable memory.

Alternatively, or in conjunction with the foregoing, sensor 504 and GPS receiver 505 can transmit data directly to non-volatile storage 503. In this embodiment, CPU 501 can access the data (e.g., location and/or event data) from memory 502. In some non-limiting embodiments, non-volatile storage 503 can comprise a solid-state storage device (e.g., a “flash” storage device) or a traditional storage device (e.g., a hard disk). In certain non-limiting embodiments, storage 503 includes mass storage for data or instructions. As an example and not by way of limitation, storage 503 can include a hard disk drive (HDD), a floppy disk drive, flash memory, an optical disc, a magneto-optical disc, magnetic tape, or a Universal Serial Bus (USB) drive or a combination of two or more of these. Storage 503 can include removable or non-removable (or fixed) media, where appropriate. Storage 503 can be internal or external to computer system 400, where appropriate. In certain non-limiting embodiments, storage 503 is non-volatile, solid-state memory. In certain non-limiting embodiments, storage 503 includes read-only memory (ROM). Where appropriate, this ROM can be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 503 taking any suitable physical form. Storage 503 can include one or more storage control units facilitating communication between processor 501 and storage 503, where appropriate. Where appropriate, storage 503 can include one or more storages 503. Although this disclosure describes and illustrates particular storage, this disclosure contemplates any suitable storage.

Specifically, GPS receiver 505 can transmit location data (e.g., latitude, longitude, etc.) to CPU 501, memory 502 or storage 503 in similar manners. In some non-limiting embodiments, CPU 501 can comprise a field programmable gate array or customized application-specific integrated circuit.

In one non-limiting embodiment, storage 503 can store past or previous sensed or received data. For example, storage 503 can store past location data. In other non-limiting embodiments, instead of storing previously sensed and/or received data, the previously sensed and/or received data can transmit the data to a server, such as server 403 shown in FIG. 4. The previous data can then be used to determine one or more health indicators which can be stored at the server. The one or more health indicators includes one or more selected from the group of licking, scratching, itching, walking, sleep, and/or sleep disruption. In other non-limiting embodiments, the one or more health indicators is performed by at least one of the wearable device, the server, or a cloud-computing platform. The server can then compare the health indicators it has determined based on the recent data it receives to the stored health indicators, which can be based on previously stored data. The server 403 can generate wellness assessment and/or health recommendation based on the previously stored data. The wellness assessment, for example, can include dermatological diagnoses, such as a flare up, ear infection, arthritis diagnoses, cardiac episode, pancreatic episode, kidney disease, eating disorders, and/or thyroid issues.

As illustrated in FIG. 5, the device 500 includes multiple network interfaces including cellular transceiver 507, wireless transceiver 508, and Bluetooth transceiver 509. Cellular transceiver 507 allows the device 500 to transmit the data, processed by CPU 501, to a server via any radio access network. Additionally, CPU 501 can determine the format and contents of data transferred using cellular transceiver 507, wireless transceiver 508, and Bluetooth transceiver 509 based upon detected network conditions. Transceivers 507, 508, and 509 can each, independently, be a transmitter, a receiver, or both a transmitter and a receiver, or a unit or device that can be configured both for transmission and reception. The transmitter and/or receiver (as far as radio parts are concerned) can also be implemented as a remote radio head which is not located in the device itself, but in a mast, for example.

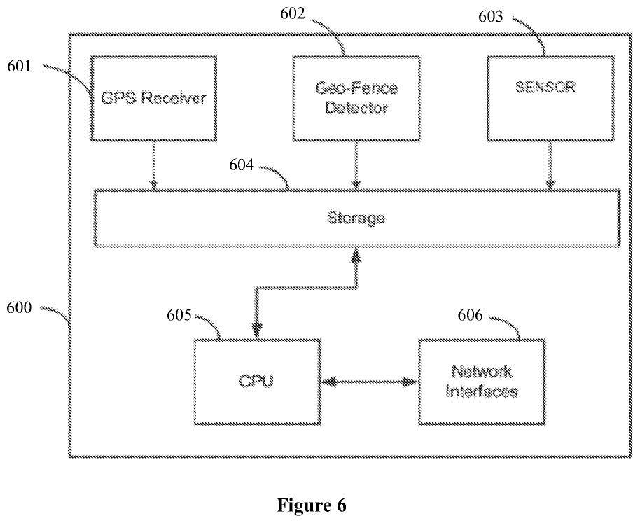

FIG. 6 is a logical block diagram illustrating a device that can be used to track and monitor a pet according to certain non-limiting embodiments. As illustrated in FIG. 6, a device 600, such as tracking device 100 shown in FIGS. 1 and 2, also referred to as a wearable device, which can include a GPS receiver 601, a geo-fence detector 602, a sensor 603, storage 604, CPU 605, and network interfaces 606. Geo-fence can refer a geolocation-fence as described below. GPS receiver 601, sensor 603, storage 604, and CPU 605 can be similar to GPS receiver 505, sensor 504, memory 502/non-volatile storage 503, or CPU 501, respectively. Network interfaces 606 can correspond to one or more of transceivers 507, 508, and 509. Device 600 can also include one or more power sources, such as a battery. Device 600 can also include a charging port, which can be used to charge the battery. The charging port can be, for example, a type-A universal serial bus (“USB”) port, a type-B USB port, a mini-USB port, a micro-USB port, or any other type of port. In some other non-limiting embodiments, the battery of device 600 can be wirelessly charged.

In the illustrated embodiment, GPS receiver 601 records location data associated with the device 600 including numerous data points representing the location of the device 600 as a function of time.

In one non-limiting embodiment, geo-fence detector 602 stores details regarding known geo-fence zones. For example, geo-fence detector 602 can store a plurality of latitude and longitude points for a plurality of polygonal geo-fences. The latitude and/or longitude points or coordinates can be manually inputted by the user and/or automatically detected by the wearable device. In alternative embodiments, geo-fence detector 602 can store the names of known WLAN network service set identifier (SSIDs) and associate each of the SSIDs with a geo-fence. In one non-limiting embodiment, geo-fence detector 602 can store, in addition to an SSID, one or more thresholds for determining when the device 600 exits a geo-fence zone. Although illustrated as a separate component, in some non-limiting embodiments, geo-fence detector 602 can be implemented within CPU 605, for example, as a software module.

In one non-limiting embodiment, GPS receiver 601 can transmit latitude and longitude data to geo-fence detector 602 via storage 604 or, alternatively, indirectly to storage 604 via CPU 605. A geo-fence can be a virtual fence or safe space defined for a given pet. The geo-fence can be defined based on a latitude and/or longitudinal coordinates and/or by the boundaries of a given WLAN connection signal. For example, geo-fence detector 602 receives the latitude and longitude data representing the current location of the device 600 and determines whether the device 600 is within or has exited a geo-fence zone. If geo-fence detector 602 determines that the device 600 has exited a geo-fence zone the geo-fence detector 602 can transmit the notification to CPU 605 for further processing. After the notification has been processed by CPU 605, the notification can be transmitted to the mobile device either directly or via the server.

Alternatively, geo-fence detector 602 can query network interfaces 606 to determine whether the device is connected to a WLAN network. In this embodiment, geo-fence detector 602 can compare the current WLAN SSID (or lack thereof) to a list of known SSIDs. The list of known SSIDs can be based on those WLAN connections that have been previously approved by the user. The user, for example, can be asked to approve an SSID during the set-up process for a given wearable device. In another example, the list of known SSIDs can be automatically populated based on those WLAN connections already known to the mobile device of the user. If geo-fence detector 602 does not detect that the device 600 is currently connected to a known SSID, geo-fence detector 602 can transmit a notification to CPU 605 that the device has exited a geo-fence zone. Alternatively, geo-fence detector 602 can receive the strength of a WLAN network and determine whether the current strength of a WLAN connection is within a predetermined threshold. If the WLAN connection is outside the predetermined threshold, the wearable device can be nearing the outer border of the geo-fence. Receiving a notification once a network strength threshold is surpassed can allow a user to receiver a preemptive warning that the pet is about to exit the geo-fence.

As illustrated in FIG. 6, device 600 further includes storage 604. In one non-limiting embodiment, storage 604 can store past or previous data sensed or received by device 600. For example, storage 604 can store past location data. In other non-limiting embodiments, instead of storing previously sensed and/or received data, device 600 can transmit the data to a server, such as server 403 shown in FIG. 4. The previous data can then be used to determine a health indicator which can be stored at the server. The server can then compare the health indicators it has determined based on the recent data it receives to the stored health indicators, which can be based on previously stored data. Alternatively, in certain non-limiting embodiments, device 600 can use its own computer capabilities or hardware to determine a health indicator. Tracking changes of the health indicator or metric using device 600 can help to limit or avoid the transmission of data to the server. The wellness assessment and/or health recommendation made by server 403 can be based on the previously stored data. The wellness assessment, for example, can include dermatological diagnoses, such as a flare up, ear infection, arthritis diagnoses, cardiac episode, pancreatic episode, kidney disease, eating disorders, and/or thyroid issues.

In one non-limiting example, the stored data can include data describing a walk environment details, which can include the time of day, the location of the tracking device, movement data associated with the device (e.g., velocity, acceleration, etc.) for previous time the tracking device exited a geo-fence zone. The time of day can be determined via a timestamp received from the GPS receiver or via an internal timer of the tracking device.

CPU 605 is capable of controlling access to storage 604, retrieving data from storage 604, and transmitting data to a networked device via network interfaces 606. In one non-limiting embodiment, CPU 605 can receive indications of geo-fence zone exits from geo-fence detector 602 and can communicate with a mobile device using network interfaces 606. In one non-limiting embodiment, CPU 605 can receive location data from GPS receiver 601 and can store the location data in storage 604. In one non-limiting embodiment, storing location data can comprise associated a timestamp with the data. In some non-limiting embodiments, CPU 605 can retrieve location data from GPS receiver 601 according to a pre-defined interval. For example, the pre-defined interval can be once every three minutes. In some non-limiting embodiments, this interval can be dynamically changed based on the estimated length of a walk or the remaining battery life of the device 600. CPU 605 can further be capable of transmitting location data to a remove device or location via network interfaces 606.

### 4. Package for Protecting Pet Wearable Device Attachment and Device Accessory

The presently disclosed subject matter also relates to a package for protecting a wearable device and device accessory.

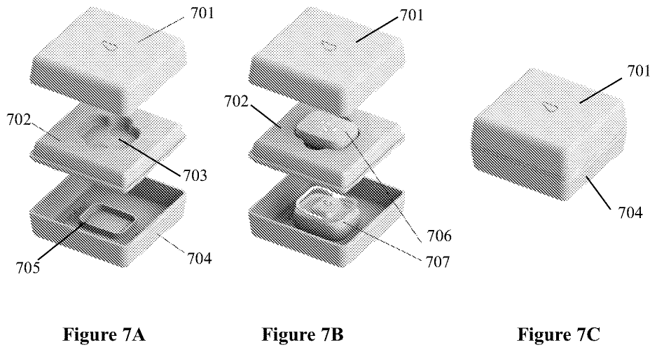

In certain embodiments, as shown in FIGS. 7A and 7B, the package comprises a top cover 701. In one non-limiting embodiment, the top cover 701 defines cartridge configured to receive a device therein. In certain embodiment, the package further comprises a middle tray 702. In one non-limiting embodiment, the middle tray 702 is positionable below the top cover 701 and the middle tray 702 includes a perimeter ledge that couples with a rim of the top cover 701. In one non-limiting embodiment, the middle tray 702 has a recessed portion 703 configured to support the device 706 therein. In one embodiment, the cartridge and the recessed portion 703 together secure the device 706 therein. In certain embodiments, the package further comprises a bottom cover 704 is positionable below the middle tray 702. In one embodiment, the bottom cover 704 defines a cartridge 705 to receive a device accessory, e.g., device attachment system 707, thereon. In certain embodiments, the top cover 701 and the bottom cover 704 are interchangeable. In certain embodiment, the middle tray 702 is nested between the top cover 701 and the bottom cover 704. The cartridge 705 of the top cover 701 can receive the device on the top side thereof while the device is disposed in the recessed portion 703 of the middle tray for a securement. This can permit enhanced structural protection for the device in transit.

Those skilled in the art will recognize that the methods and systems of the present disclosure can be implemented in many manners and as such are not to be limited by the foregoing exemplary embodiments and examples. In other words, functional elements being performed by single or multiple components, in various combinations of hardware and software or firmware, and individual functions, can be distributed among software applications at either the client level or server level or both. In this regard, any number of the features of the different embodiments described herein can be combined into single or multiple embodiments, and alternate embodiments having fewer than, or more than, all of the features described herein are possible.

Functionality can also be, in whole or in part, distributed among multiple components, in manners now r known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that can be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications can be made to the elements and operations described above to obtain a result that remains within the scope of the systems and processes described in this disclosure.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments can include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates certain non-limiting embodiments as providing particular advantages, certain non-limiting embodiments can provide none, some, or all of these advantages.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications can be made to the elements and operations described above to obtain a result that remains within the scope of the systems and processes described in this disclosure.

What is claimed is:

1. A wearable device attachment system for a pet comprising:
a flexible case configured to receive a collar charm device therein, the case having a front and a back;
a clip coupled to the back of the case, the clip comprising a one-piece unit having a top member, a bottom member, a first side member, a second side member, and a transverse member, wherein the top member is distanced from and opposite to the bottom member and the first side member is distanced from and opposite to the second side member, wherein the top and bottom members are curved away from the back of the case and the clip is symmetrical about the transverse member;
wherein the clip is configured to couple with a collar band, the collar band is insertable and lockable between the back of the case and the clip.

2. The wearable device attachment system of claim 1, wherein the case surrounds the transverse member to form a bump on the back of the case, wherein the bump is configured to couple the clip with the case, wherein the collar band is lockable between a back surface of the bump and front surfaces of the first and second side members.

3. The wearable device attachment system of claim 3, wherein the back surface of the bump interfaces with collar band to prevent the collar band from dislodging from the clip.

4. The wearable device attachment system of claim 1, wherein the collar band is curved towards the back of the case when locked with the clip.

5. The wearable device attachment system of claim 4, wherein a curvature of the collar band prevents the collar band from dislodging from the clip.

6. The wearable device attachment system of claim 1, wherein the clip is configured to be removably attached to the collar band.

7. The wearable device attachment system of claim 1, wherein the transverse member is coupled with the top member of the clip, wherein the collar band inserts through a front surface of the bottom member of the clip.

8. The wearable device attachment system of claim 1, wherein a width of the collar band is less than the distance between the top member and the bottom member.

9. The wearable device attachment system of claim 1, further comprising a collar charm device that couples with the case.

10. The wearable device attachment system of claim 9, wherein the collar charm device has a front face, a bottom face, and a sidewall disposed between the front face and the bottom face, wherein the sidewall comprises a frictioned surface.

11. The wearable device attachment system of claim 10, wherein the flexible case comprises an elastomer material, wherein the frictioned surface of the sidewall interfaces with the interior sidewall of the flexible case to secure the collar charm device within the case.

12. A wearable device attachment for a pet comprising:
a flexible case configured to receive a collar charm device therein, the case having a front and a back;
a clip coupled to the back of the case, the clip comprising a one piece unit having a top member, a bottom member, a first side member, a second side member, and a transverse member, wherein the top member is distanced from and opposite to the bottom member and the first side member is distanced from and opposite to the second side member, wherein the top and bottom members are curved away from the back of the case and the clip is symmetrical about the transverse member, wherein the clip is configured to lock a collar band with the clip and is configured to receive and lock the collar band between the back of the case and the clip.

13. The wearable device attachment system of claim 12, wherein the case surrounds the transverse member to couple the clip with the case, wherein the clip is configured to lock the collar band between front surfaces of the first and second side members and the transverse member.

14. The wearable device attachment system of claim 12, wherein the distance between the top member and the bottom member is greater than a width of the collar band.

15. A package for protecting a wearable device and device accessory, comprising:
a top cover defining cartridge configured to receive a device therein;
a middle tray positionable below the top cover, the middle tray includes a perimeter ledge that couples with a rim of the top cover, the middle tray having a recessed portion configured to support the device therein, wherein the cartridge and the recessed portion together secure the device therein; and
a bottom cover positionable below the middle tray, the bottom cover defining a cartridge to receive a device accessory thereon, wherein the top cover and the bottom cover are interchangeable.

16. The package of claim 15, wherein the middle tray is nested between the top cover and the bottom cover.

17. A wearable device system, comprising:
a collar charm device having a front face, a bottom face, and a sidewall disposed between the front face and the bottom face, wherein the sidewall comprises a frictioned surface; and
a flexible case to receive the collar charm therein, the case comprising an elastomer material, wherein the frictioned surface of the sidewall interfaces with the interior sidewall of the flexible case to secure the collar charm within the case.

18. The wearable device system of claim 17, further comprising a clip secured with the flexible case.

19. The wearable device according to claim 17, wherein the wearable device comprises one or more processors and one or more non-transitory memories, wherein the one or more non-transitory memories further comprise instructions operable when executed by the one or more of the processors to cause the wearable device to:
enter a power-saving mode, wherein the power-saving mode restricts or delays the execution of one or more work items performed by the wearable device.

20. The wearable device according to claim 17, wherein the wearable device comprises one or more processors and one or more non-transitory memories, wherein the one or more non-transitory memories further comprise instructions operable when executed by the one or more of the processors to cause the wearable device to:
collect data from one or more sensors;
determine, based on the data, one or more health indicators of the pet; and
generate, based on the one or more health indicators of the pet, a wellness assessment of the pet.

21. The wearable device according to claim 20, wherein the one or more health indicators includes one or more selected from the group of licking, scratching, itching, walking, sleep, and/or sleep disruption.

22. The wearable device according to claim 17, wherein the wearable device comprises one or more processors and one or more non-transitory memories, wherein the one or more non-transitory memories further comprise instructions operable when executed by the one or more of the processors to cause the wearable device to:
transmit the data from the one or more sensors to one or more servers or cloud-computing platform, wherein the determining of the one or more health indicators is performed by at least one of the wearable device, the one or more servers, or the cloud-computing platform.
